(19) United States
(12) Patent Application Publication
(10) Pub. No.: US 2007/0080265 A1
(43) Pub. Date: Apr. 12, 2007

(54) Automatically self-locking utility clamp

(76) Inventor: Peter F. Schaffer, San Diego, CA (US)

Correspondence Address: Donald W. Meeker;Patent Agent, 924 East Ocean Front #E, Newport Beach, CA, 92661, US

(21) Appl. No.: 11/248,971

(22) Filed: Oct. 12, 2005

(51) Int. Cl. F16L 3/08

(52) U.S. Cl. 248/65

(57) ABSTRACT

Two partial annular rigid clamp sections pivotally attached to spaced pivot pins on a base pivot open to receive an item and pivot closed automatically due to the pressure of the item on bottom ends of the clamps. Mating teeth interlock on the upper ends of the clamps with the ends overlapping to encircle an item, such as a pipe, tool, hose, or other item to be secured to a structure and automatically lock it within the clamp.

### BACKGROUND OF THE INVENTION

1. Field of the Invention

The present invention relates to a hanger device, and particularly to a bracket having automatic self-locking clamps, each clamp comprising two hinged arms that have mating teeth which mesh to lock the clamp by insertion of an item to be secured into an open clamp causing the clamp to close automatically and lock around the item, the bracket being mounted to vertical horizontal or sloping surfaces as needed for securing items including pipes, tools, hoses or any other items requiring securing to a structure.

2. Description of the Prior Art

Many clamp means exist for holding items including pipes, tools, hoses and other items to be secured to a structure. Generally they are open clamps which secure an item by tension between two sides of the clamp, such as clamps on a wall for holding long handled tools, such as brooms, rakes, shovels and other tools with handles.

Plastic bands have been used as hangers, and they have been clamped fast in a hanger member by means of fastening screws. This type of pipe suspension can be used only for light-weight pipes, since it is not very strong. Steel band hangers have also been used, which have slots in one end and a threaded bolt on the other end that allow the steel band to be tightened.

Other pipe hangers used to suspend pipes from building structures are composed of several separate pieces, such as, a mounting, two semi-circular brackets to enclose the pipe, and nuts and bolts to secure the pieces. These conventional pipe hangers take many man hours to assemble and install.

Various clamping arrangements have been developed to allow one person to install a pipe, such as snap fit metal or plastic brackets that mount to structural beams, but they do not provide a completely encircling securely locked clamp.

U.S. Pat. No. 4,955,574, issued Sep. 11, 1990 to Freier, describes a pipe clip that comprises a baseplate, a pair of opposed arcuate-shaped strap segments; a flexible connecting-strut connected between the baseplate and each strap segment at a point that divides the strap segment into an inner end portion and an outer end portion, and mutually engageable closure means on the outer end portions of the strap segments to lock the straps in place around a pipe. The struts maintain the strap segments in disengaged position with their inner end portions adjacent each other and their outer end portions apart to permit the insertion of a pipe into the clip whereby the force of inserting a pipe into the clip against the inner end portions of the strap segments brings the outer end portions together and the closure means into engagement.

U.S. Pat. No. 5,478,033, issued Dec. 26, 1995 to Hungerford, Jr., claims a pipe clamp which includes a base having support elements extending outwardly therefrom and a deflection means connected to the support elements for deflecting and facilitating the securement of a pipe in the clamp and the release of the pipe from the clamp. The deflection means may include relief means disposed thereon for facilitating deflection conducive to pipe installation and removal. A deflection means is preferably attached to each of the support elements. The invention also includes two clamp means having upper and lower ends wherein each of the clamp means is preferably attached at its lower end to one of the deflection means. The upper end of each of the clamp means has locking means for connecting the clamp means together. The pipe clamp is preferably formed from a unitary and continuous sheet of metal which allows for lower manufacturing costs and thus, a more economical clamp.

U.S. Pat. No. 5,697,585, issued Dec. 16, 1997 to Hungerford, Jr., discloses a pipe clamp which includes a base having support elements extending outwardly therefrom and a deflection means connected to the support elements for deflecting and facilitating the securement of a pipe in the clamp and the release of the pipe from the clamp. The deflection means may include relief means disposed thereon for facilitating deflection conducive to pipe installation and removal. A deflection means is preferably attached to each of the support elements. The invention also includes two clamp means having upper and lower ends wherein each of the clamp means is preferably attached at its lower end to one of the deflection means. The upper end of each of the clamp means has locking means for connecting the clamp means together. The pipe clamp is preferably formed from a unitary and continuous sheet of metal which allows for lower manufacturing costs and thus, a more economical clamp.

U.S. Pat. No. 5,133,523, issued Jul. 28, 1992 to Daigle, is for a suspendable conduit bracket lock system. A modular system is provided for the securement of a conduit to longitudinal constructional member defining in transverse cross-section continuous integral upper and side surfaces in which the side surfaces, at their lower ends, turn inwardly and upwardly to form respective internal longitudinal tracks within the member that are co-directional with a longitudinal axis of the member, which includes elements for horizontal suspension to the interior of the structural building. The system includes a back bracket having, in transverse cross-section, a partial polygonal back surface having several faces, at least one face comprising an externally protruding radial portion including elements for selectable lockable engagement between the radial portion and a longitudinal segment of the constructional member, the bracket having front surfaces defining resilient nesting elements having a partially opened-faced geometry, the nesting elements proportioned to the exterior geometry of the conduit to be secured.

U.S. Pat. No. 5,590,859, issued Jan. 7, 1997 to Lord, provides a ratcheting pipe hanger assembly for managing pipes and cables. The hanger is described as having the capability to swivel, easily adjust height and with respect to pipes, reduce noise/vibration associated therewith by containing the pipe suspended thereby in a ratcheting holder. The hanger assembly employs a single hanger pin so that the swiveling capability is provided. The invention further, simplifies the installation of a pipe, in particular, and also of other conduits in need of management and suspension since the hanger can be affixed to a joist, rafter or stud at an estimated location. The assembly can then be adjusted to favorably engage the conduit to be hung or managed.

U.S. Pat. No. 5,024,405, issued Jun. 18, 1991 to McGuire, shows a pipe clamp with a pipe gripper affixed to a base, wherein the base may selectively engage a support bar. The base includes a pair of feet and opposing clips which permit selective engagement of the pipe clamp to the support bar. The pipe clamp is initially oriented perpendicular to the support bar and a center pin is disposed in an aperture. The pipe clamp is then rotated to dispose the feet into apertures of the support bar and the clips engage the backside of the bar. The pipe gripper includes a tongue and a mating fork having a guide prong and securing prong, wherein interlocking teeth prevent displacement of the tongue from within the fork to thereby retain a pipe. The pipe is removed from the clamp through the separation of the tongue and the fork by flexing the guide prong in a radial direction so as to permit torsion of the tongue relative to the fork.

U.S. Pat. No. 4,119,285, issued Oct. 10, 1978 to Bisping, indicates a clip for holding pipe, cable and the like on a support member, which consists of a pair of clamping jaws attached in spaced relation to an elastically deformable base portion. The base portion has two first bearing locations disposed in spaced relation and one second bearing location positioned between and spaced from each of the first bearing locations. At least a part of the base portion has an arcuate or arched shape with the convex side facing toward the clamping jaws. The second bearing location is positioned at the crown on the convex side of the arched shaped part of the base portion. The clip is resiliently biased into gripping relation with the support member at the first and second bearing locations, and, when the clamping jaws are pressed together, the gripping action at the bearing location is released and the clip can be moved relative to the support member.

U.S. Pat. No. 2,375,513, issued May 8, 1945 to Bach, is for a pipe hanger system with clamps that screw together.

U.S. Pat. No. 1,824,459, issued Sep. 22, 1931 to Beckwith, shows a two-armed bracket for supporting pipes.

What is needed is a clamp which locks closed automatically to encircle an item and retain it securely in place attached to a structure.

### SUMMARY OF THE INVENTION

An object of the present invention is to provide two pivotable curved clamp sections which clamp together upon installing an item within two bottom ends of the clamp sections to pivot two top ends of the clamp sections closed in an overlapping relationship with interlocking teeth to lock the clamp closed automatically to encircle the item and retain it securely in place attached to a structure.

Another object of the present invention is to provide an automatic locking utility clamp which is fabricated simply and inexpensively from few parts.

In brief, a base has two spaced pivot pins which each hold one of the two automatic interlocking sections of the automatic locking clamp of the present invention. In an open clamp receiving position, the two top ends of the clamp sections are spread apart to receive an item to be secured between them. The two bottom ends of the clamp sections are elevated above the pivot points at the bottom of the clamp sections. When an item is placed between the two clamp sections the item bears against the two bottoms of the two clamp sections to pivot the two clamp sections and cause the tops of the clamp sections to close over the item in an overlapping array with a set of teeth on an inner surface of one clamp section intermeshing with another mating set of teeth on an outer surface of the other clamp section to lock the clamp closed completely encircling the item to lock the item in the clamp.

The automatic locking clamp can be attached to any vertical, horizontal, or sloped surface on a structure for securing pipes, hoses, tools such as long handled tools, such as brooms, rakes, shovels and other tools with handles, or any other items to be secured to the structure.

An advantage of the present invention is that an item is locked in the clamp instantly and automatically by inserting the item into an open clamp to close and lock the clamp automtically.

Another advantage of the present invention is that is saves time and effort by automatically locking without a need to fasten the sides of the clamps together.

An additional advantage of the present invention is that it is simple to construct from a few pre-made parts.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the automatic locking clamp of the present invention in a closed locked position;

FIG. 2 is a front elevational view of the automatic clamp of FIG. 1 with an item in position for insertion into the open clamp;

FIG. 3 is a front elevational view of the automatic locking clamp of FIG. 1 with an item lowered partially into the open clamp;

FIGS. 4-6 are each front elevational views of the automatic locking clamp of FIG. 1 showing an item inserted into the open automatic locking clamp and gradually lowering into the clamp to cause the clamp to close around the item and lock it in place;

FIG. 7 is an exploded perspective view of the automatic locking clamp of the invention with the parts aligned for assembly.

### BEST MODE FOR CARRYING OUT THE INVENTION

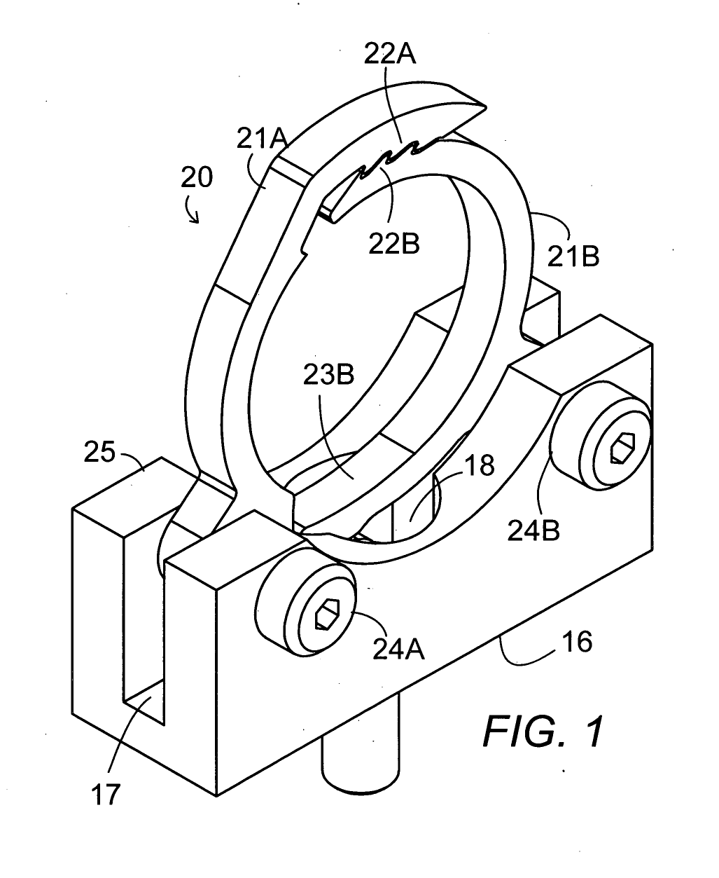

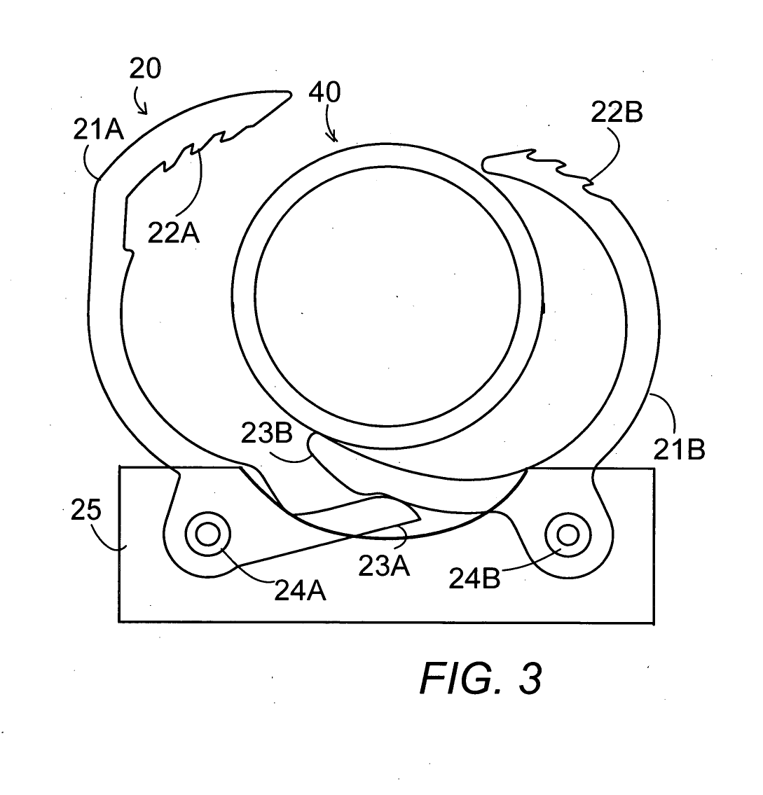

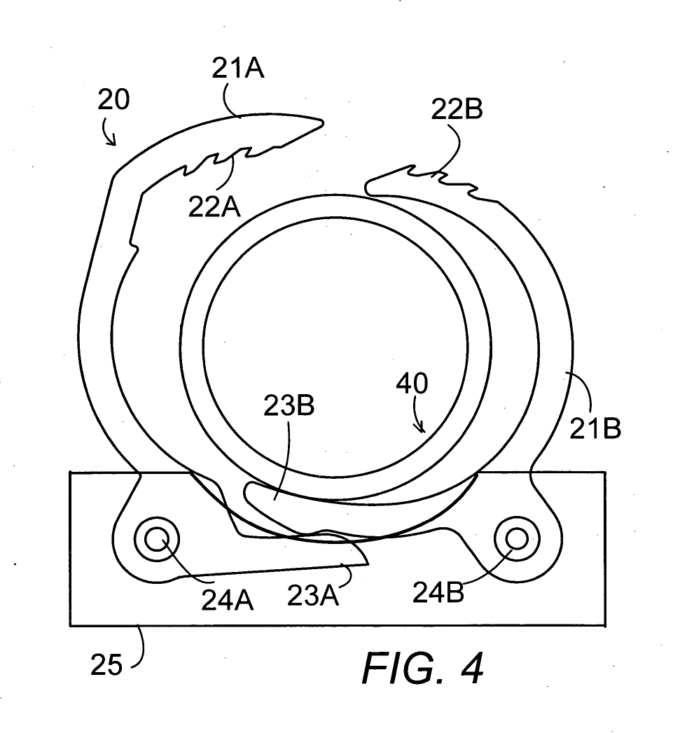

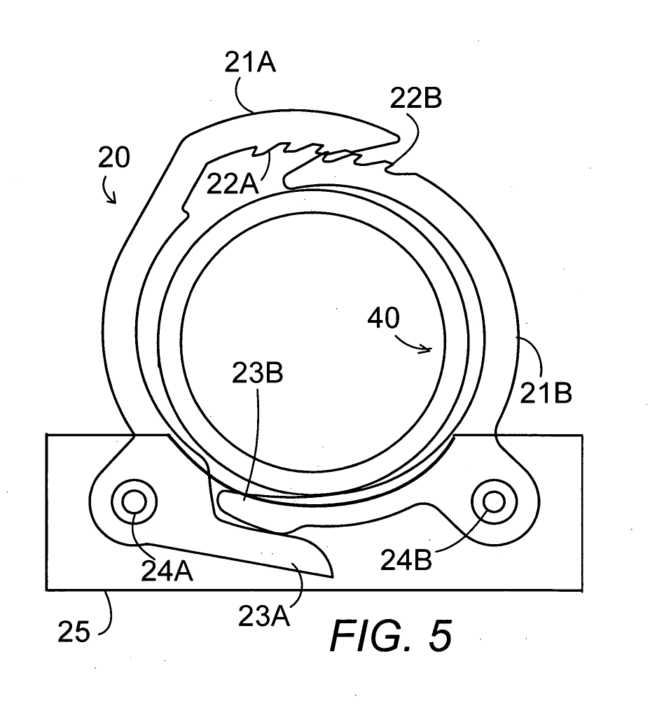

In FIGS. 1-7, an automatic locking clamp device 20 comprises a base 25 with two clamp sections 21A and 21B attached to spaced pivot pins 24A and 24B in the base.

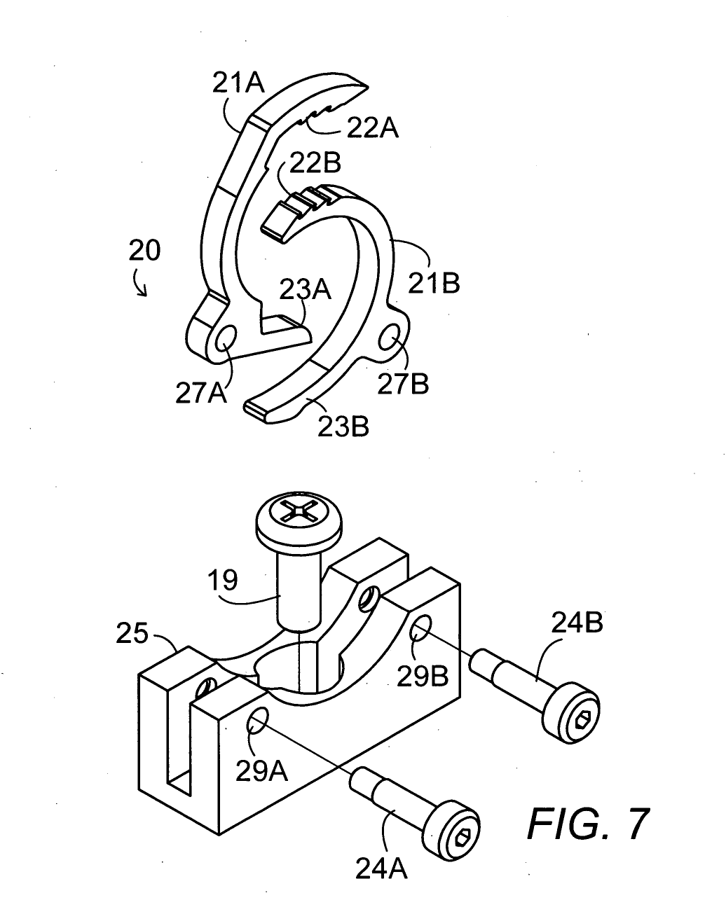

The base 25 comprises a frame with a flat bottom 16 for positioning against an external surface and an interior slot 17 with a pair of spaced openings 29A and 29B in each of two opposing sides of the frame with the spaced openings aligned across the interior slot, as shown in FIG. 7. A pair of pivot pins 24A and 24B are inserted in the openings across the interior slot through mating openings 27A and 27B in the clamp sections 21A and 21B.

A means of attaching the base to an external surface may comprise openings in the base with screws or nails or other standard fasteners attaching the base to metal or wood external surfaces or a center pin 19 extending from a bottom of the base through a center bottom opening 18 and a fastening element attached to the pin, such as a screw or bolt or cotter pin or other fastener. The automatic locking clamp is attachable to any external surface where it is desired to attach an item such as a pipe, tool, hose, or any other item requiring storage that fits within the clamp.

The first clamp section 21a comprises a rigid member in the shape of over half of an annular ring with protruding teeth 22A on an interior surface of an upper end of the first clamp section. The first clamp section 21A is pivotally attached to a first pivot pin 24A of the pair of pivot pins with an open side of the annular ring facing a second pivot pin 24B of the pair of pivot pins.

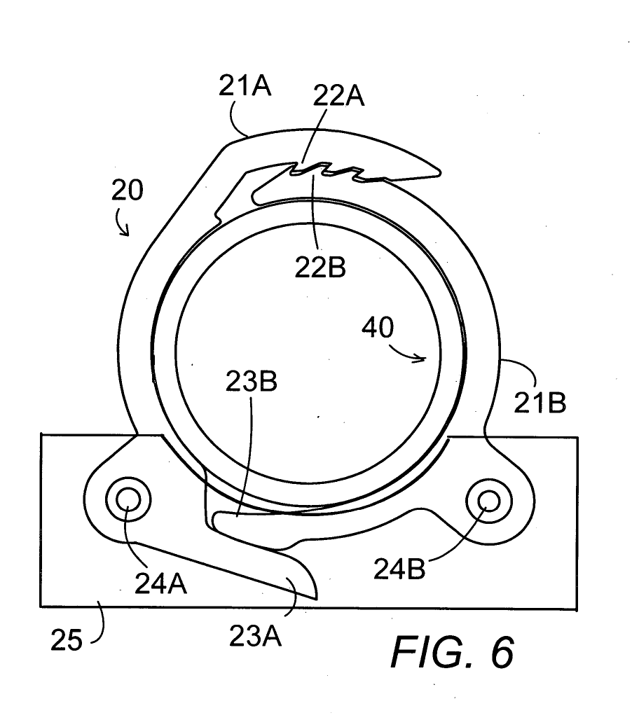

The second clamp section 21B comprising a rigid member in the shape of over half on an annular ring slightly smaller in diameter than the first clamp section 21A so that the first clamp section 21A can overlap the second clamp section 21B when the two clamp sections are closed together is in FIGS. 1 and 6. The second clamp section 21B has mating protruding teeth 22B on an exterior surface of an upper end of the second clamp section. The second clamp section 21B is pivotally attached to the second pivot pin 24B with an open side of the annular ring facing the first pivot pin 21A.

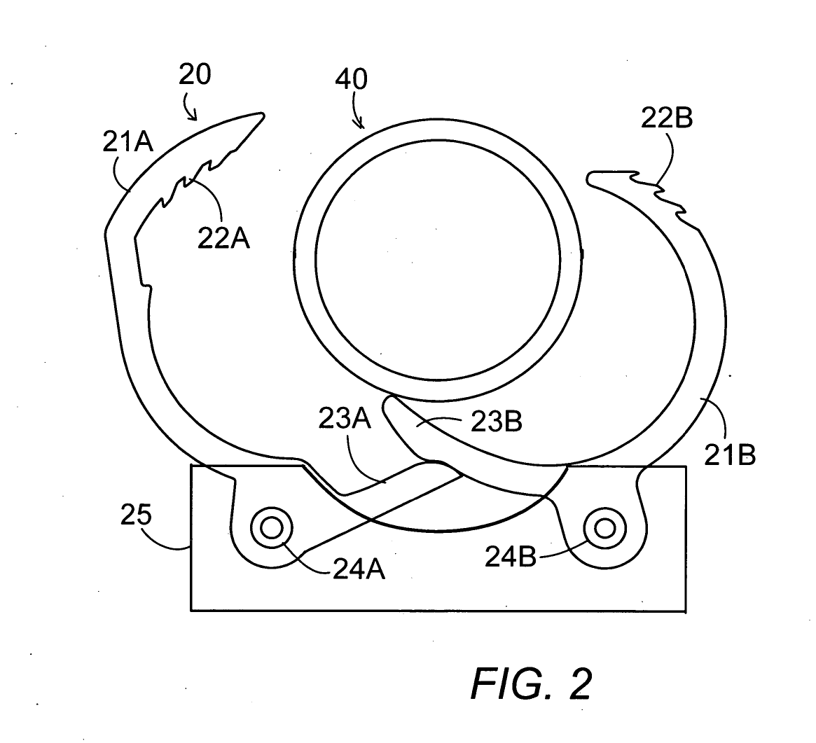

The pivot pins are positioned so that in an open position as in FIG. 2, top ends of the clamp sections with teeth 22A and 22B are spread apart and bottom ends 23A and 23B of the clamp sections overlap with bottom tips of the clamp sections elevated above the pivot points 24A and 24B so that an item 40 to be secured placed on the bottom ends causes the bottom ends to pivot downwardly and the top ends to pivot together in an overlapping relationship around the item 40 to be secured to a structure with the mating teeth 22A and 22B interlocked together and the two clamp sections 21A and 21B locked together encircling the item 40 to retain the item within the encircling automatic interlocking clamp sections 21A and 21B.

In practice, FIGS. 2-6 show the item 40 to be attached to a structure gradually pivoting the two clamp sections 21A and 21B until they automatically lock together encircling the item 40 to lock it in place, as in FIG. 6.

The components of the clamp device are preferably fabricated of a non-corrosive rigid material such as coated metal or rigid nylon or plastic and may be insulated for use with copper pipe.

It is understood that the preceding description is given merely by way of illustration and not in limitation of the invention and that various modifications may be made thereto without departing from the spirit of the invention as claimed.

What is claimed is:

1. An automatic locking clamp device comprising:
a base comprising a frame with a flat bottom for resting on an external surface and an interior slot with a pair of spaced openings in each of two opposing sides of the frame with the spaced openings aligned across the interior slot, a pair of pivot pins inserted in the openings across the interior slot, and a means of attaching the base to an external surface;
a first clamp section comprising a rigid member in the shape of over half of an annular ring with protruding teeth on an interior surface of an upper end of the first clamp section, the first clamp section pivotally attached to a first pivot pin of the pair of pivot pins with an open side of the annular ring facing a second pivot pin of the pair of pivot pins;
a second clamp section comprising a rigid member in the shape of over half on an annular ring with mating protruding teeth on an exterior surface of an upper end of the second clamp section, the second clamp section pivotally attached to the second pivot pin with an open side of the annular ring facing the first pivot pin, the pivot pins positioned so that in an open position, top ends of the clamp sections are spread apart and bottom ends of the clamp sections overlap with bottom tips of the clamp sections elevated above the pivot points so that an item to be secured when placed on the bottom ends causes the bottom ends to pivot downwardly and the top ends to pivot together in an overlapping relationship around the item with the mating teeth interlocked together and the two clamp sections locked together encircling the item to retain the item within the encircling automatically interlocked clamp sections.

2. The device of claim 1 wherein the means of attaching the base comprises a center pin extending from a bottom of a base and a fastening element attached to the pin.

3. The device of clam 1 wherein the means of attaching the base comprises openings in the base through which standard fasteners secure the base to an external surface.
